(19) United States
(12) Patent Application Publication
(10) Pub. No.: US 2008/0028633 A1
(43) Pub. Date: Feb. 7, 2008

(54) Drying system

(76) Inventor: H. Clay Dingee, Anthem, AZ (US)

Correspondence Address: JACKSON WALKER LLP, 901 MAIN STREET, SUITE 6000, DALLAS, TX, 75202-3797, US

(21) Appl. No.: 11/888,522

(22) Filed: Aug. 1, 2007

Related U.S. Application Data
(60) Provisional application No. 60/834,595, filed on Aug. 1, 2006.

(51) Int. Cl. F26B 3/06

(52) U.S. Cl. 34/446; 34/443; 34/586; 34/592; 71/11; 110/221

(57) ABSTRACT

A method and apparatus for drying and reducing the particle size of malleable material. Preferred embodiments of the invention include a drying apparatus for use with a malleable material, comprising a blower, an airlock feeder, a main line which contains an accelerator, a conditioning chamber, and a dehydration chamber, a polishing line which contains an accelerator, a conditioning chamber, and a dehydration chamber, and a squid line blower for providing pressurized heated air to the apparatus. An alternative preferred embodiment of the invention comprises a method of drying and size reducing malleable material.

### CLAIM OF PRIORITY

This application claims priority of U.S. Provisional Ser. No. 60/834,595, entitled “IMPROVED DRYING SYSTEM” filed Aug. 1, 2006, incorporated herein by reference.

### FIELD OF THE INVENTION

The present invention relates to a method and apparatus for drying and reducing the particle size of malleable material. Preferred embodiments of the invention include a drying apparatus for use with a malleable materials and a method of drying and size reducing malleable material.

### BACKGROUND OF THE INVENTION

There is a need in many industries to economically recover valuable products from what are considered to be wastes having a high moisture content and a non-uniform particle size. It is desirable to recover valuable products with greatly reduced moisture content, substantially uniform size, and without significant loss of beneficial attributes of the material. These industries include the agricultural, food processing, mining, coal, pulp and paper, and oil and gas industries. As one example, in livestock feed lots raw manure is produced in large volumes, and the most common revitalization mechanism is to apply it to land in the same water shed. However, such operations have become an environmental concern for a number of reasons, and in view of the large volume of manure produced (e.g. estimated to be about 1.4 billion tons of manure in the U.S.A. Alone in 1998), stockpiles of manure and other waste products are becoming a significant cause for concern.

While presently a cause for concern, raw manure, when properly processed, has many applications. It can be used as a fertilizer, a soil amendment for such areas as parks, golf courses, and lawns, and in a number of other situations. In known systems, raw manure is typically mechanically milled or ground with hammer mills or grinders prior to processes in which the manure is dried in a rotary drum drier at between 350-500° F. using an external heat source. A roll compact or is then used to form brunettes from the pulverized and dried raw manure, which are then re-ground to a desired granule size. Such systems have a number of environmental and economic drawbacks that make them largely, or wholly, not cost effective.

Not only is conventional processing marginally or not cost effective, it also significantly reduces the quality of the processed product. The heat used for drying not only is produced expensively and with environmental adverse consequences, but it destroys a significant amount of the organic material in the manure. Also, the forming process produces a greater volume of airborne products that can present a health and safety hazard, requiring the utilization of air pollution controls.

### SUMMARY OF INVENTION

The present invention achieves technical advantages as an apparatus for drying and reducing particle size of a malleable material by including a polishing line which includes an accelerator. Apparatus may further include a conditioning chamber, a dehydration chamber, and a squid line blower for providing pressurized heated air to the apparatus. An alternative preferred embodiment of the invention comprises a method of drying and size reducing malleable material.

### BRIEF DESCRIPTION OF THE DRAWINGS

FIG. 1 is a schematic view of exemplary apparatus according to the present invention for practicing the exemplary method according to the present invention.

### DETAILED DESCRIPTION OF THE PRESENT INVENTION

According to the present invention, a method and apparatus are provided that overcome the drawbacks associated with the reduction of a large variety of different types of malleable material (such as manure, municipal sludge, coal and coal fines, food wastes, pulp and paper wastes, mine tailings, and dredge spoils). The method and system according to the present invention avoid almost all of the problems associated with the prior art systems and methods. According to the present invention one can produce a product having a much lower moisture content (typically a quarter or less of the original moisture content) while significantly reducing the average particle size (e.g. by at least 20%), and making the particle size substantially more uniform. The method of the invention can be practiced without any, or much less, external heat.

In a preferred embodiment, a blower may be a device for generating airflow, and may generate a high velocity air flow, e.g. air at a velocity of about 100-200 mph. An example (only) of a blower suitable for the purposes of the present invention is the Roots Blower, Model 14 AZRA5, manufactured by the Roots Dresser Company of Connersville, Ind.

In a preferred embodiment, an airlock feeder may be capable of feeding material into the high speed airflow provided by the blower so that the material is entrained in the airflow. An example of an airlock feeder could comprise a conveyor having an inlet and an outlet vertically above the inlet for conveying the material (such as manure) into the open top of a hopper. The material falls out of the bottom of the hopper (e.g. a live bottom hopper) into operative association with a pair of screw conveyors which convey the material to a star feeder, having a star wheel that makes substantially sealing engagement with the surrounding housing. The star wheel is driven by a conventional motor, and when operating, feeds material into the high speed air flow within a conduit so that the material is entrained in an air flow.

In a preferred embodiment, an accelerator (also called a jet mill) is capable of increasing the speed of the air flow with entrained particles to super-cyclonic speed, such that at least some of the particles are moving at super-cyclonic speed, that is about 400-500 mph. In the preferred form, the accelerator establishes a substantially bullet profile of air flow with entrained material. The air flow profile has a substantially zero velocity at the periphery thereof, immediately adjacent the interior of the housing, and a velocity of over about 400 mph at the center of the air flow, that is the center of the housing of a second end of a central conduit. Midway between the housing wall and the center of the housing the air flow speed of profile may be approximately 250 mph.

The accelerator preferably further comprises a substantially annular chamber surrounding the second end of a central conduit within a housing, and a connection from the blower in the annular chamber between the first and second ends of the central conduit. In a preferred embodiment, the connection downstream-most portion is spaced a distance from the second end of the central conduit in the dimension of elongation of the housing.

In a preferred embodiment, a conditioning chamber may be a device capable of reducing particle size and drying particles. In a preferred form, super-cyclonic speed air with entrained particles passes through a conduit to at least one particle size reducer and drier. Preferably two (or more) in-series conditioning chambers are provided as a size reducer and drier, a top outlet from the first chamber or vessel being connected to the inlet for the second chamber or vessel, and the top outlet from the second chamber or vessel being connected to the inlet of the particle separator. The inlet to the first vessel is tangential, and each of the vessels is generally cyclone-shaped. The second vessel inlet is vertically above the outlet from the first vessel, e.g. about 1-4 feet, and the first conduit connecting them is generally curved and preferably has a radius of about 28 feet.

In a preferred embodiment of a dehydration cone, the inlet is also vertically above the outlet from the second vessel, e.g. about 3-6 feet, and the second conduit interconnecting the outlet and the inlet is also generally curved. In a preferred embodiment, all of the inlets are tangential, imparting a whirling action to the air with entrained particles introduced into each of the vessels and the separator. The second conduit preferably has a larger diameter (e.g. by at least 10%) than the first conduit.

In a preferred embodiment, each of the generally cyclone-shaped vessels has directional breaker bars mounted therein which create small turbulent areas so that new incoming solids entrained in the air have particle-to-particle collisions with solids already in the chamber, for example at an impact angle of about 60°. This results in particle size reduction (and moisture release), and ultimately the smaller size particles pass through the open bottom of the central tube or sleeve in each of the chambers to pass to the respective outlet conduit.

The longer the particles are within a chamber, the more particle-to-particle collisions that there are, and the greater the size reduction will be. The retention time within the chambers can be adjusted by utilizing valved auxiliary air inlets adjacent the bottom of each of the vessels, and/or by adjusting the effective length of sleeves.

A dehydration cone is capable of separating moist air from particles, which are discharged from the bottom of the dehydration cone. The separator or dehydration cone may comprise a cyclonic separator, in which air with entrained particles swirls within the separator, after being tangentially introduced by inlet, with the particles being discharged from the bottom, and with the moisture laden air which entrain the particles being discharged through an outlet.

In a preferred embodiment, the invention may comprise an apparatus including both a main line and a polishing line. In this embodiment, a main line may include an accelerator, a conditioning chamber, and a dehydration cone. The polishing line may include a second accelerator, a second conditioning chamber, and a second dehydration chamber. The main line may be operatively connected to the polishing line such that the malleable material moves first through the main line, and subsequently through the polishing line.

A preferred embodiment of the invention may further comprise a squid line blower, which is operatively connected to the apparatus at several points in order to provide pressurized air to the apparatus.

The invention specifically comprises all narrower ranges within a broad range. For example, reducing the moisture content by at least 20% means by 30-50%, 50-99%, 60-80%, and all other narrower ranges within the broad range.

In a preferred embodiment, the present invention may not include an external heat source, and no heat is added except by the generation of air at a high pressure. The currently claimed invention is capable of processing raw malleable material which may have a moisture content of between 50% and 75%, preferably between 55% and 70%, and most preferably about 70% to form material which has a moisture content of between 5% and 15%, most commonly around 10%. The particle size of processed material can be as low as 200 mesh. In addition, the current invention is capable of creating a uniform particle size, and it is common to observe that around 55% of material which has undergone one round of processing conforms to the desired mesh size. Further, the invention is capable of producing a product in which organics or pathogens were undetectable using conventional laboratory techniques in cases where the moisture content of the material had been reduced to <10%.

Materials appropriate for use with the currently claimed apparatus and method include, but are not limited to, crustaceans, paper mill sludge, animal waste or sludge, manure, human waste or sludge, wet distillery grain, bark, compost, thatch, algae, kelp, food waste, and other forms of malleable materials as well as municipal sludge, coal and coal fines, wood waste, pulp and paper mill waste, mine tailings, dredge spoils, or combinations thereof.

The method associated with the currently claimed invention has been observed by an independent laboratory to generate only 33% of the emissions which are allowable under EPA guidelines, making this process environmentally desirable.

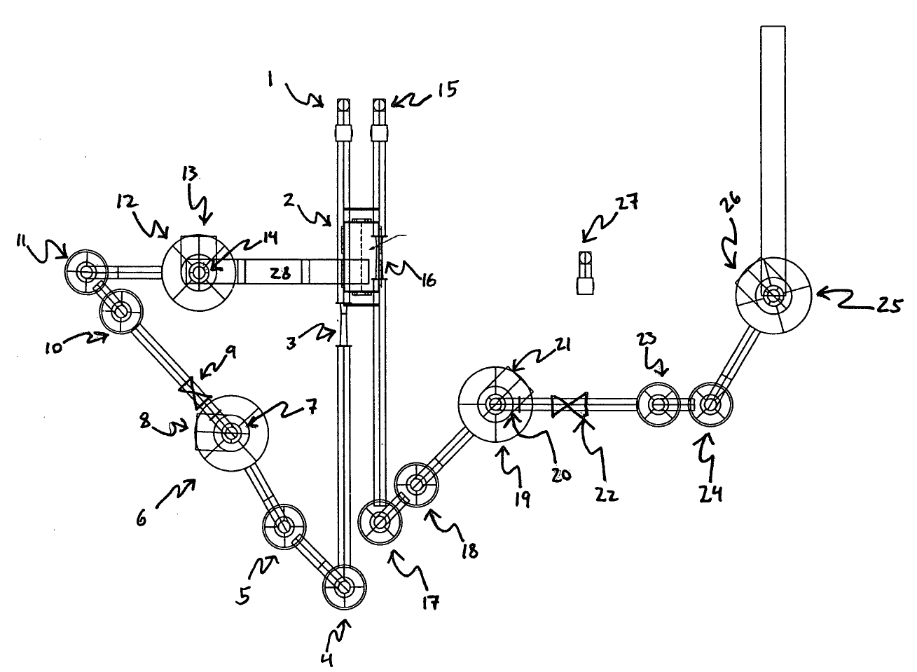

FIG. 1 illustrates an exemplary apparatus system according to the present invention for drying and reducing the particle size of a material, such as manure, municipal sludge, coal and coal fines, wood waste, pulp and paper mill waste, mine tailings, dredge spoils, or combinations thereof. While the invention will be described primarily with respect to treatment of manure, it is to be understood that these other materials, or a wide variety of other materials which desirably need to have the moisture content thereof reduced, as well as the average particle size thereof reduced and the uniformity of the particle size enhanced, may be treated.

The exemplary apparatus according to the present invention is illustrated generally by reference to FIG. 1. It comprises as major components thereof one or more blowers (1, 15), one or more squid line blowers (27), one or more air lock feeders (2), one or more single valve supplemental air accelerators (SAA), one or more conditioning chambers (4, 5, 10, 11, 17, 18, 23, 24), and one or more D-hydration cones (6, 12, 19, 25).

A preferred embodiment of an apparatus according to the present invention may comprise a Main Line and a Polishing Line such that material entering the apparatus is first processed through the Main Line and subsequently processed through the Polishing Line. Each of the Main Line and the Polishing Line may comprise one or more blowers (1, 15), one or more squid line blowers (27), one or more air lock feeders (2), one or more single valve supplemental air accelerators (SAA), one or more conditioning chambers (4, 5, 10, 11, 17, 18, 23, 24), and one or more D-hydration cones (6, 12, 19, 25).

In a preferred embodiment of the invention, a ‘Main Line’ Mach1 air lock Feeder (2) is operatively connected to receive air from a main line blower (1) located perpendicular to the infeed of material with the rotary paddles extended into and parallel to the air stream.

The embodiment further comprises a first ‘Main Line’ single valve supplemental air accelerator (SAA) venturi (3) supplied with dedicated heat and pressurized air from a squid line blower (27) to increase the shearing process and velocity collision in a first and a second conditioning chamber (4 and 5, respectively).

The first SAA venturi (3) is in fluid communication with the first and a second conditioning chamber (4 and 5, respectively) designed to uniformly blend the material as it sets up the particle entrance to a first D-hydration cone (6). The first and second conditioning chambers (4 and 5, respectively) are each equipped with two valved side air accelerator injector ports supplying dedicated heated and pressurized air from the separate squid line blower (27). Both conditioning chambers (4 and 5) are equipped with adjustable pressure sleeves inside the cone to facilitate retention time.

The second conditioning chamber is in fluid communication with the first D-hydration cone (6), and material entering into this size cone de-accelerates to allow for vaporized moisture to separate from the material and discharge to a first exhaust duct (8) connected to the D-hydration cone (6) as the material continues on a downward path to a first venturi elbow (7). The first exhaust duct (8) outlet is equipped with a manual adjustable damper control to regulate discharge pressure and exhaust should be collected at this point to transfer that moisture to a remote location.

The valved first venturi elbow (7) is connected to a next in line valved second SAA venturi (9) re-accelerating the material once more, and both are supplied with dedicated heat and pressurized air from the squid line blower (27) as the material enters a third conditioning chamber (10) which is in fluid communication with a fourth conditioning chamber (11), each equipped with two valved side air accelerator injector ports, supplying dedicated heated and pressurized air from the squid line blower (27). The conditioning chambers are also equipped with an adjustable pressure sleeve for retention time.

The fourth conditioning chamber (11) is in fluid communication with a second D-hydration cone (12), which also separates the moisture from the particulates. The moisture will exit through a second top exhaust duct outlet (13) connected to the second D-hydration cone (12) while the material continues downward through a second venturi elbow (14) to the discharge airlock/auger (28). The discharge moisture should be collected by the same duct as the moisture from the first exhaust duct (8) outlet connected to the first D-hydration chamber (6) in parallel.

At this point in the process the moisture in the material has been separated and reduced significantly, with the particulates continuing on to the discharge auger (28) and subsequently being transferred back up to the Mach1 air lock feeder (2) to enter the ‘Polishing Line’ second stage. Once inside the Mach1 air lock feeder (2) cell the material re-enters a second air lock feeder operatively connected to receive air from a second blower (15) and enters the new air stream with a third single valve SAA venturi (16) to increase shearing and de-watering the material as it enters this final drying stage.

The third SAA venturi (16) is in fluid communication with a fifth and a sixth conditioning chamber (17 and 18, respectively) to receive the material. Chamber cones are each equipped with two valved side air accelerator injector ports supplying dedicated heat and pressurized air from the squid line blower (27) to further separate the moisture laden material and prepare it for a third D-hydration Cone (19).

The third D-hydration Cone (19) receives the material; this cone is equipped with one valved side air accelerator port located at the collared entrance to the cone supplying dedicated heat and pressurized air from the squid line blower (27), enhancing the drying process. The material continues downward thru a venturi elbow (20) as the moisture exits through the top discharge exhaust duct (21) and is collected and removed remotely in parallel with the previously mentioned exhaust ducts.

Next the particulates are re-accelerated from the third venturi elbow (20) thru a fourth single valve supplementary air accelerator (SAA) venturi (22) which is in fluid communication with a seventh and an eighth conditioning chamber (23 and 24, respectively), each of which is supplied with dedicated heat and pressurized air from the squid line blower (27).

The seventh and the eighth conditioning chambers (23 and 24, respectively) are each equipped with two valved side air accelerator injector ports supplying dedicated heat and pressurized air from the squid line blower (27) producing regulated heated chambers to deliver the material to a fourth D-hydration Cone (25).

This final D-hydration Cone (25) comes equipped with a valved side air accelerator injector port supplying dedicated heat and pressurized air from the squid line blower (27) to facilitate the actual moisture allowed in material throughput. The accepted moisture/material content is released downward thru a discharge airlock, while the remaining moisture is discharged to the top of this cone via a fourth exhaust duct (26) to be collected remotely in parallel with the discharge from the previously mentioned exhaust ducts.

The “squid line blower” (27) delivers dedicated air to a ‘Transducer Heat Manifold’ designed to deliver pressurized heated air to a multi port manifold for distribution to all the venturi apparatus and the side air accelerator ports located on the various conditioning chambers and the D-hydration Cones.

Although preferred embodiments of the present invention are illustrated in the accompanied drawings and described in the foregoing detailed description, it will be understood that the invention is not limited to the embodiments disclosed but is capable of numerous rearrangements, modifications and substitutions in parts and elements without departing from the spirit of the invention. For example, any number of fastening mechanisms on the tabs of the liner can be used to accomplish the objectives of restraining the liner to the waste container, and thereafter can be used to secure the liner for disposal. Further, any number of motifs, such as cartoon characters or appealing designs, in the liner can be used to serve to motivate use of the trainer by the toddler and serve as an indicia that the liner needs to be replaced.

Though the invention has been described herein with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A drying apparatus for use with a malleable material comprising:
a) a blower;
b) an airlock feeder operatively connected to receive air from said blower;
c) a main line operatively connected to the blower, wherein the main line comprises an accelerator, a conditioning chamber, and a dehydration cone; and
d) a polishing line operatively connected to the main line, wherein the polishing line comprises an accelerator, a conditioning chamber, and a dehydration cone.

2. The drying apparatus of claim 1, further comprising a squid line blower adapted to provide pressured heated air to the apparatus.

3. The drying apparatus of claim 1, wherein the blower is adapted to generate an airflow velocity of between about 100 and 200 miles per hour.

4. The drying apparatus of claim 1, wherein the airlock feeder is adapted to feed material into the high speed airflow provided by the blower so that the material is entrained in the airflow.

5. The drying apparatus of claim 1, wherein the accelerator is adapted to increase the speed of the air flow with entrained particles to super-cyclonic speed.

6. The drying apparatus of claim 4, wherein super-cyclonic speed is between about 400 and about 500 miles per hour.

7. The drying apparatus of claim 1, wherein the conditioning chamber is adapted to reducing particle size and drying particles.

8. The drying apparatus of claim 1, wherein the dehydration cone is adapted to separating moist air from particles, and wherein particles are discharged from the bottom of the dehydration cone.

9. A drying apparatus for use with a malleable material comprising:
a) a blower;
b) an airlock feeder operatively connected to receive air from said blower;
c) a main line operatively connected to the blower, wherein the main line comprises an accelerator, a conditioning chamber, and a dehydration cone; and
d) a squid line blower adapted to provide pressured heated air to the apparatus.

10. The drying apparatus of claim 9, wherein the airlock feeder is adapted to feed material into the high speed airflow provided by the blower so that the material is entrained in the airflow.

11. The drying apparatus of claim 9, wherein the accelerator is adapted to increase the speed of the air flow with entrained particles to super-cyclonic speed.

12. A method of drying and size reducing a malleable material, comprising the steps of:
(a) feeding the malleable material with a first moisture content and first average particle size into an air stream;
(b) allowing the material to enter a main line comprising an accelerator, a conditioning chamber, and a dehydration cone, such that particles of the material are reduced in size due to material-material collisions, and such that moisture is separated from the particles;
(c) allowing the material to enter a polishing line comprising an accelerator, a conditioning chamber, and a dehydration cone, such that particles of the material are reduced in size due to material-material collisions, and such that moisture is separated from the particles; and
(d) separating the material, having a second moisture content at less than the first moisture content, and a second average particle size less than the first size, from the air stream.

13. The method of claim 8, wherein the steps (a)-(d) are practiced without the use of any external heat source.

14. The method of claim 8, wherein the steps (a)-(d) are practiced using a squid line blower as a source of pressured air.

15. The method of claim 8, wherein (d) takes place by cyclonic separation.

16. The method of claim 8, wherein (a)-(d) are practiced so that the second moisture content is less than about one quarter the first moisture content, and so that the second particle size is more uniform than the first particle size.

17. The method of claim 8, wherein (a)-(d) are practiced using as the material manure, municipal sludge, coal and coal fines, food wastes, pulp and paper mill wastes, mine tailings, dredge spoils, or combinations thereof.

18. The method of claim 8, wherein (a)-(d) are practiced using an organic material having a final organic content in (d) not more than about 15% less than the initial organic material content in (a), and wherein (a)-(d) are further practiced so that the second moisture content is less than about one quarter the first moisture content.

19. The method of claim 14, wherein (a)-(d) are practiced using manure as the material, and so that the second particle size is more uniform than the first particle size.

20. The method of claim 8, wherein the first moisture content is between about 50% and 75%, and the second moisture content is between about 5% and 15%.
